(19) United States
(12) Patent Application Publication
(10) Pub. No.: US 2016/0171966 A1
(43) Pub. Date: Jun. 16, 2016

(54) ACTIVE NOISE CANCELLING DEVICE AND METHOD OF ACTIVELY CANCELLING ACOUSTIC NOISE

(71) Applicants: STMicroelectronics S.r.l., Agrate Brianza (IT); STMicroelectronics (Shenzhen) R&D Co. Ltd, Shenzhen (CN)

(72) Inventors: Luca Molinari, Piacenza (IT); Xi Chun Ma, Shenzhen (CN); Sandro Dalle Feste, Novaro (IT); Martino Zerbini, Abbiategrasso (IT)

(21) Appl. No.: 14/863,228

(22) Filed: Sep. 23, 2015

(30) Foreign Application Priority Data
Dec. 10, 2014 (IT) TO2014A001028

(51) Int. Cl. G10K 11/178; H04R 3/02

(52) U.S. Cl. CPC G10K 11/1782; H04R 3/02; H04R 2460/01

(57) ABSTRACT

An active noise cancelling device including a sensor configured to convert acoustic signals into first audio signals and a speaker acoustically coupled to the sensor A control stage is configured to control the speaker based on the first audio signals to cause the speaker to produce cancelling acoustic waves that tend to suppress acoustic noise components in the acoustic signals. The control stage includes sigma-delta modulator digital filters.

### BACKGROUND

1. Technical Field

The present disclosure relates to an active noise cancelling device and to a method of actively cancelling acoustic noise.

2. Description of the Related Art

As is known, active noise cancelling is becoming more and more used to improve performance of audio systems, such as headphones, headsets, hearing aids, microphones and the like. This trend is also encouraged by recent developments in the field of microelectromechanical systems (MEMS), which provided extremely effective and sensitive devices, such as microphones and speakers, having the additional advantage of very low power consumption.

Active noise cancelling essentially consists of detecting acoustic noise produced by noise sources through a microphone at a given location, and using a feedback control based on microphone response to produce acoustic waves that tend to cancel noise by destructive interference in a band of interest (e.g., an audible band roughly comprised between 16 Hz and 16 kHz).

Most of known active noise cancelling systems are based on analog circuitry, namely analog filters, because it is normally possible to achieve lower phase delay compared to digital solutions. Filters are in fact included in the feedback control loop and phase delay is well-known to be a critical aspect for stability of feedback system.

Apart from a general trend toward digital solutions, analog active noise cancelling systems present some limitations in terms of poor flexibility, accuracy requirements of components, power consumption, area occupation and, in the end, cost. For example, it is quite difficult, or even impossible at all, sometimes, to provide for adjustable filter response and every component, including resistors, should be accurately trimmed to ensure expected performance. Thus, purely analog implementations are not ideally suited to improve miniaturization and flexibility of use.

On the other hand, known solutions that involve digital processing based on conventional chains of IIR filters may suffer from low sampling rate typical of audio systems (e.g., 48 kHz) and phase delay, which in turn may undermine stability, as already mentioned. Other active noise cancelling systems envisage higher sampling rates, but these solutions are normally demanding in terms of processing capability. Devices that meet processing requirements (e.g., Digital Signal Processors, DSP) are usually costly and power consuming.

### BRIEF SUMMARY

An aim of the present disclosure is to provide an active noise cancelling device and a method of cancelling acoustic noise that allow some or all of the above described limitations to be overcome and, in particular, favors stability of digital active noise cancelling systems.

### BRIEF DESCRIPTION OF THE SEVERAL VIEWS OF THE DRAWINGS

For a better understanding of the disclosure, an embodiment thereof will be now described, purely by way of non-limiting example and with reference to the attached drawings, wherein:

FIG. 1 is a block diagram of an audio system including a active noise cancelling device according to an embodiment of the present disclosure;

FIG. 2 is a schematic representation of a signal format used in the active noise cancelling device of FIG. 1;

FIG. 3 is a more detailed block diagram of a portion of the active noise cancelling device of FIG. 1;

FIG. 4 is a detailed block diagram of a first filter of the active noise cancelling device of FIG. 1;

FIG. 5 is a detailed block diagram of a second filter of the active noise cancelling device of FIG. 1;

FIG. 6 is a block diagram of an audio system including a active noise cancelling device according to another embodiment of the present disclosure; and

FIG. 7 is perspective view of a component of the audio system of FIG. 1.

### DETAILED DESCRIPTION

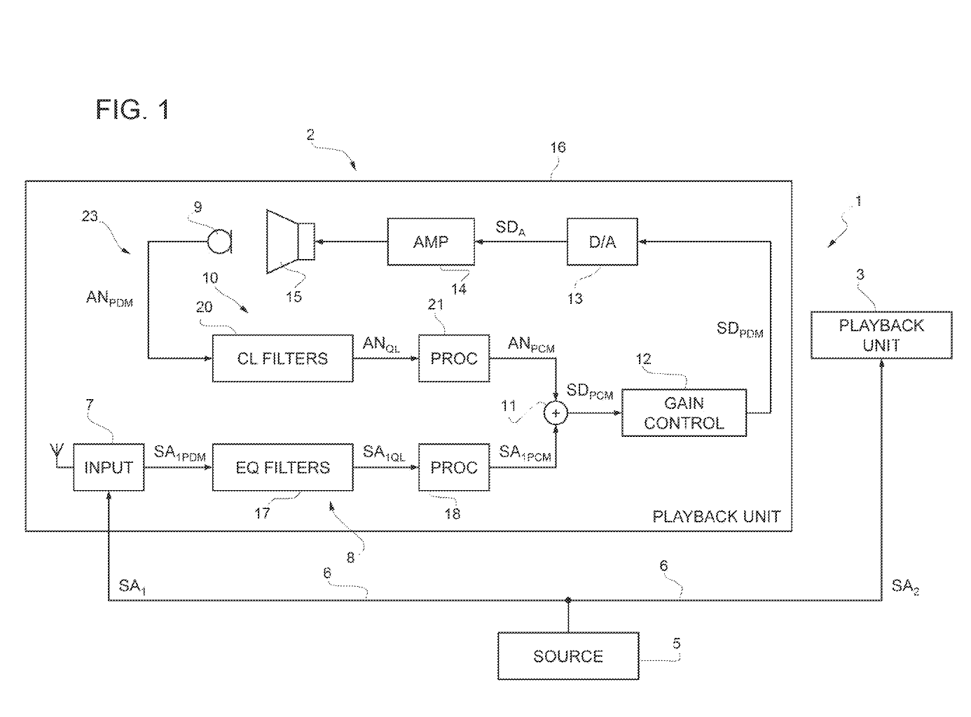

In FIG. 1, numeral 1 designates an audio system in accordance with an embodiment of the present disclosure and provided with an active noise cancelling function. The audio system 1 comprises a playback unit 2 and a playback unit 3, both coupled to a signal source 5 that is configured to respectively send audio signals SA₁, SA₂. The playback unit 2 and the playback unit 3 may be, for example, left and right earpieces of a headphone assembly. The signal source 5 may be for example, but not limited to, a tuner, a stereo or home theatre system, a cellphone or an audio file player, such as audio file player modules included in a smartphone, a tablet, a laptop or a personal computer.

In one embodiment, the audio signals SA₁, SA₂ supplied by the signal source 5 are oversampled digital signals in single-bit pulse density modulation (PDM) format (e.g., with a sampling frequency of 3 MHz) and the connection to the playback units 2, 3 is established through wires 6. In other embodiments, however, the first audio signals SA₁ and second audio signals SA₂ may be coded in pulse code modulation (PCM) format or may be analog signals. The audio signals SA₁, SA₂ may represent left audio signals and right channel audio signals, respectively.

In the embodiment of FIG. 1, the playback unit 2 and the playback unit 3 have the same structure and operation. Accordingly, reference will be made hereinafter to the playback unit 2 for the sake of simplicity. It is however understood that what will be described and illustrated is also applicable to the playback unit 3 and, if provided, to any further playback unit.

The playback unit 2 comprises an input interface 7, a signal processing stage 8, a microphone 9, an acoustic noise processing stage 10, a signal adder 11, a gain control stage 12, a D/A stage 13, an analog amplifier 14 and a loudspeaker 15, all enclosed within a casing 16.

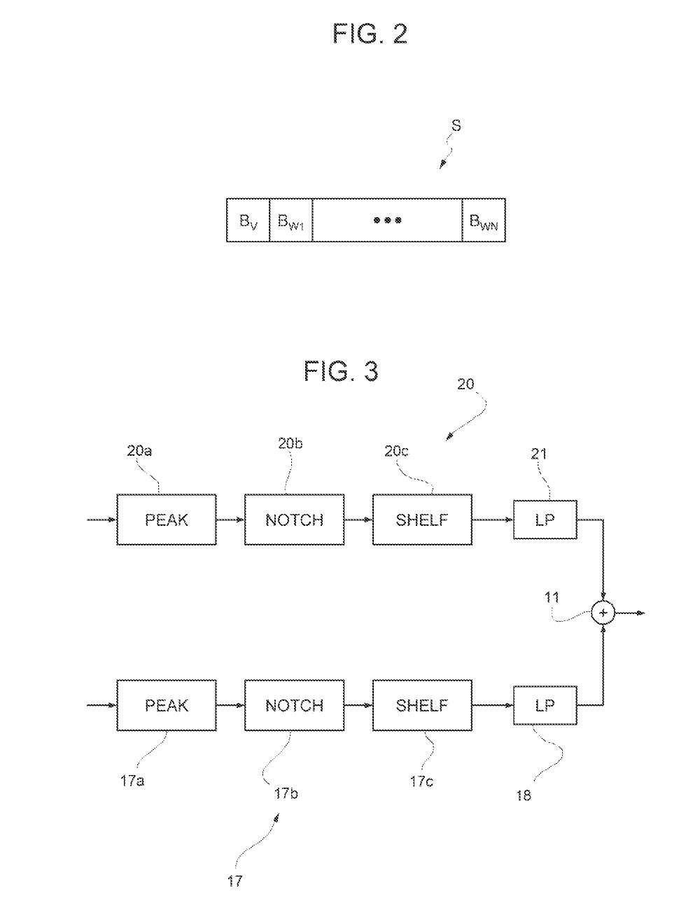

The input interface 7 is coupled to the signal source for receiving the first audio signal SA₁ and is configured to convert the first audio signal SA₁ into a PDM audio signal SA_{1PDM} in single-bit or multibit PDM format. In one embodiment (see FIG. 2), each sample S of a signal in multibit PDM format includes one value bit B_{V} for the sample value (corresponding to the sample value of single-bit PDM format) and a fixed number N of weight bits B_{W1}, . . . , B_{WN} (e.g., five weight bits) defining a sample weight. The input interface 7 may be provided also with wireless communication capability, for receiving audio signals sent by a wireless signal source.

The signal processing stage 8 receives the PDM audio signal SA_{1PDM} from the input interface 7 and supplies a PCM audio signal SA_{1PCM} in PCM format to the signal adder 11.

The signal processing stage 8 includes a set of equalization filters 17 and a processing module 18 with lowpass transfer function and a passband gain which, in one embodiment, may be unity. In one embodiment, the equalization filters 17 may include a cascade of a peak filter 17a, a notch filter 17b and a shelf filter 17c, as shown in FIG. 3. Other sets of filters may be however used, according to the need for specific applications.

The output of the equalization filters 17 is a quantized audio signal SA_{1QL} in logarithmic multibit PDM format. As herein understood, a logarithmic multibit PDM format is a multibit PDM format in which the weight of each sample is represented in a logarithmic scale. In one embodiment, the weight of each sample is represented in base-2 logarithmic scale. In other words, the weight bits B_{W1}, . . . , B_{WN} of each sample represent the base-2 logarithm of the weight of the sample.

The processing module 18 applies a gain factor and converts the quantized audio signal SA_{1QL} into a PCM audio signal SA_{1PCM} in PCM format, which is fed to a first input of the signal adder 11. In one embodiment, the gain factor may be 1. The lowpass transfer function helps to keep the quantization noise low outside the audio band.

The microphone 9 is arranged to detect acoustic noise reaching the inside of the casing 16 from the surrounding environment. In one embodiment, the microphone 9 is a digital microphone and is configured to provide an acoustic noise signal AN_{PDM} in oversampled PDM format, with the same sampling frequency as the audio signal SA₁ (here 3 MHz). In another embodiment, an assembly including analog microphone and a sigma-delta modulator could be provided in place of the digital microphone.

The acoustic noise processing stage 10 receives the acoustic noise signal AN_{PDM} from the microphone 9 and supplies a filtered audio signal to the signal adder 11.

The acoustic noise processing stage 10 comprises a set of control loop filters 20 and a processing module 21 with lowpass transfer function and passband gain greater than unity. The control loop filters 20 are configured to suppress signal components corresponding to acoustic noise detected by the microphone 9 and may include a cascade of a peak filter 20a, a notch filter 20b and a shelf filter 20c, as shown in FIG. 3. Also in this case, other sets of filters may be used, according to the need for specific applications.

The output of the control loop filters 20 is a quantized acoustic noise signal AN_{QL} in logarithmic multibit PDM format, wherein the weight of each sample is represented in the same logarithmic scale as in the quantized audio signal SA_{1QL}.

The processing module 21 applies a gain factor G0 (e.g., 100) in the respective passband and converts the quantized acoustic noise signal AN_{QL} into a PCM acoustic noise signal AN_{PCM} in PCM format, which is fed to a second input of the signal adder 11. Also in this case, the lowpass transfer function helps to keep the quantization noise low outside the audio band.

The signal adder 11 combines the PCM audio signal SA_{1PCM} and the PCM acoustic noise signal AN_{PCM}, respectively received at its first and second input, into a PCM driving signal SD_{PCM} in PCM format.

The gain control stage 12 includes a sigma-delta modulator configured the to convert the PCM driving signal SD_{PCM} into a PDM driving signal SD_{PDM} in single-bit or multibit PDM format and to apply a scaling function so that the PDM driving signal SD_{PDM} complies with the input dynamic of the D/A stage 13, the analog amplifier 14 and the loudspeaker 15.

The D/A stage 13 includes a lowpass filter and is configured to convert the PDM driving signal SD_{PDM} into an analog driving signal SD_{A}, which is supplied to the loudspeaker 15 through the amplifier 14. In one embodiment, the D/A stage 13 may be integrated in the gain control stage 12, e.g., where a class D amplifier is used.

The microphone 9, the acoustic noise processing stage 10, the gain control stage 12, the D/A stage 13, the analog amplifier 14 and the loudspeaker 15 form an active noise cancelling device 23 that is configured to attenuate acoustic noise within the casing 16 of the playback unit 2.

Acoustic noise is collected by the microphone 9 and converted by the control loop filters 20 into a cancelling component of the driving PDM driving signal SD_{PDM} that, after further conversion into the analog driving signal SD_{A}, causes the loudspeaker 15 to produce cancelling acoustic wave and suppress acoustic noise by destructive interference.

The control loop filters 20 may have any suitable transfer function that effectively achieves noise cancelling and, in one embodiment, they include the peak filter 20a, the notch filter 20b and the shelf filter 20c, as already mentioned.

At least one and, in one embodiment, all of the control loop filters 20 are sigma-delta modulator digital filters, exploiting base-2 logarithmic quantization.

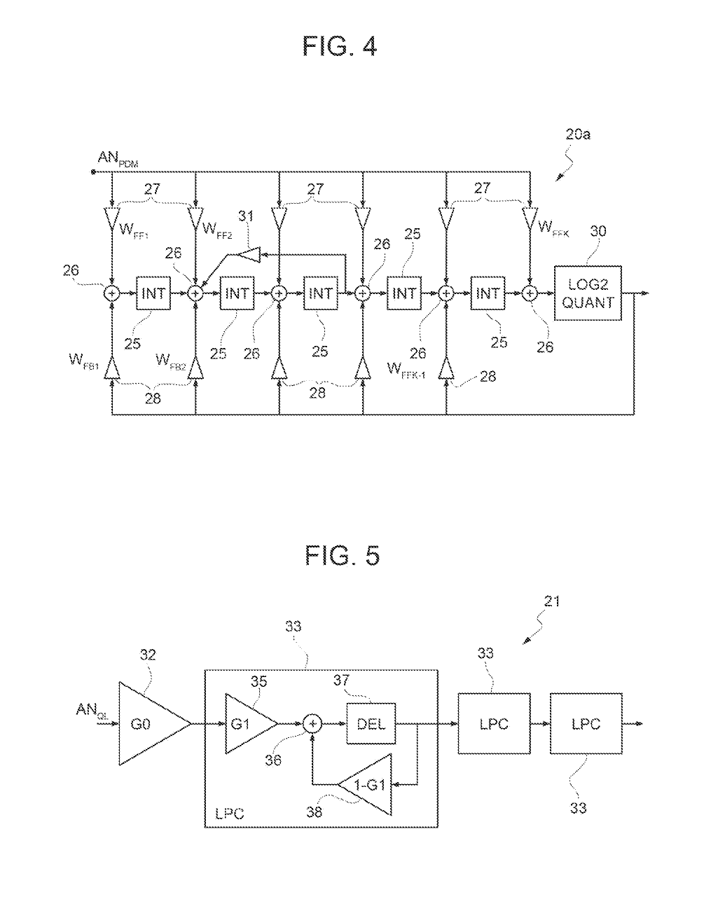

The control loop filters 20 may be in the Cascade-of-Integrators FeedBack form (CIFB), which is illustrated by way of example in FIG. 4 for the peak filter 20a. However, other sigma-delta modulators, with different structure, could be used.

The CIFB peak filter 20a comprises a plurality of integrator modules 25, a plurality of adder modules 26, a plurality of forward filter modules 27, a plurality of feedback filter modules 28 and a logarithmic quantizer 30.

The adder modules 26 and the integrator modules 25 are arranged alternated to form a cascade in which each adder module 26 feeds into a respective subsequent integrator module 25 and each integrator module 25 feeds into a respective subsequent adder module 26. One more adder module 26 is located between the most downstream integrator module 25 and the logarithmic quantizer 30.

Each forward filter module 27 is configured to apply a respective forward filter coefficient W_{FF1}, W_{FF2}, . . . , W_{FFK} to an input signal, i.e., the acoustic noise signal AN_{PDM} for the peak filter 20a, and to supply the resulting signal to a first input of a respective one of the adder modules 26.

Each feedback filter module 28 is configured to apply a respective feedback filter coefficient W_{FB1}, W_{FB2}, . . . , W_{FBK-1} to an output signal of the logarithmic quantizer 30 and to supply the resulting signal to a second input of a respective one of the adder modules 26, except the adder module 26 adjacent to the logarithmic quantizer 30.

In one embodiment, the forward filter coefficient W_{FF1}, W_{FF2}, . . . , W_{FFK} and the feedback filter coefficient W_{FB1}, W_{FB2}, . . . , W_{FBK-1} are programmable and a transfer function of the peak filter 20a has a zero at the Nyquist frequency, that improves attenuation of out-of-band quantization noise.

In one embodiment, the peak filter 20a includes also an internal feedback filter module 31, that applies an internal feedback filter coefficient to the output of one of the integrator modules 25 and supplies the resulting signal to a third input of one of the upstream adder modules 26.

The logarithmic quantizer 30 quantizes the output signal of the adjacent adder module 26 using a logarithmic scale. In one embodiment, the logarithmic quantizer 30 is a base-2 logarithmic quantizer and provides a multibit PDM signal ranging in module from 2^{-M} to 2^{M}, M being the number of bits for the weight of each sample.

The other control loop filters 20 (the notch filter 20b and the shelf filter 20c in the embodiment described) have the same CIFB structure, possibly with a different number of integrators in the cascade and filter coefficient selected to implement the desired filtering functions.

An example of the processing module 21 is illustrated in FIG. 5 and comprises a gain stage 32 and a plurality of lowpass filter cells 33 in cascade. The gain stage 32 is configured to apply the gain factor G0 to an input signal of the processing module 21, i.e., the quantized acoustic noise signal AN_{QL} received from the control loop filters 20. The lowpass filter cells 33 in one embodiment are equal to one another and have unity gain. The structure of one of the lowpass filter cells 33 is shown in FIG. 5. In one embodiment, the lowpass filter cells 33 comprise each a first gain module 35, configured to apply a gain factor G1 to an input signal of the lowpass filter cells 33; an adder module 36; a delay module 37; and a second gain module 38, configured to apply a gain factor 1-G1 to an output signal of the delay module 37. The adder module 36 combines output signals of the first gain module 35 and of the second gain module 38 and supplies a resulting signal to the delay module 37, that is configured to apply a unity step delay (i.e., a delay of one sample).

In one embodiment, the equalization filters 17 include sigma-delta modulator digital filters in CIFB form. Thus, the equalization filters 17 have the general structure described with reference to FIG. 4 for the peak filter 20a, possibly with a different number of integrators and different filter coefficients. However, other sigma-delta modulators, with different structure, could be used.

Likewise, the structure of the processing module 18 is similar to the structure of the lowpass amplifier filter 20, except in that the overall gain is unity and a different number of lowpass filter cells may be included.

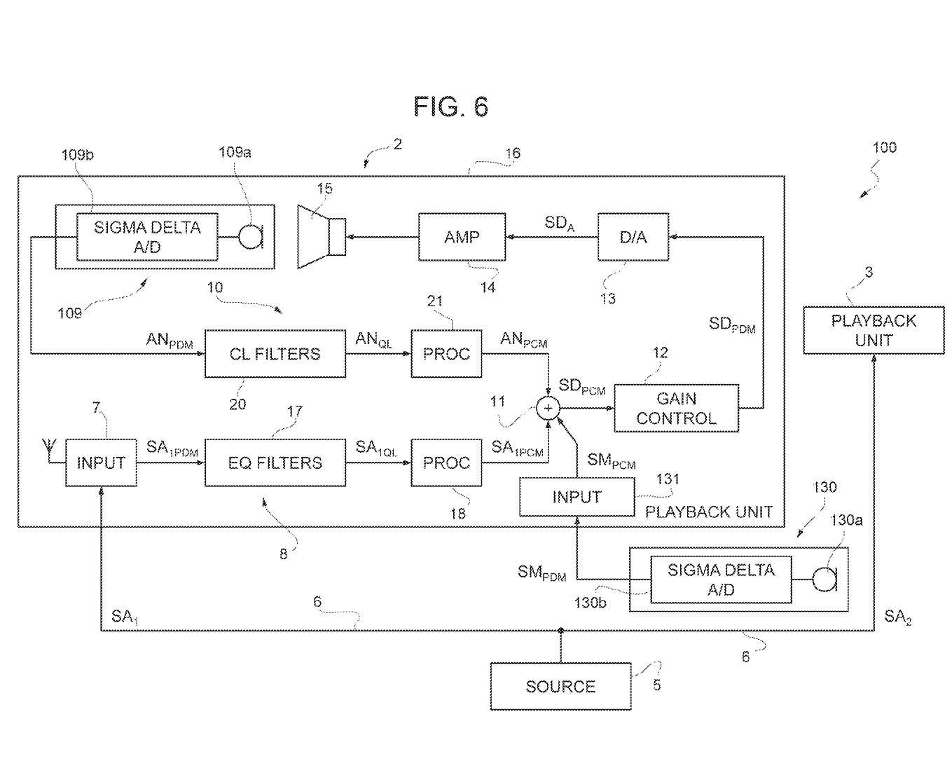

According to another embodiment, illustrated in FIG. 6, an audio system 100 has substantially the structure of the audio system of FIG. 1 and includes an acoustic sensor 109 in place of the digital MEMS microphone 9. Moreover, the audio system 100 comprises an additional forward acoustic sensor 130.

The acoustic sensor 109 comprises an analog microphone 109a and a sigma-delta A/D converter 109b coupled to the microphone 109a. The sigma-delta A/D converter 109b is configured to receive an analog audio signal from the microphone 109a and to convert the analog audio signal into the acoustic noise signal AN_{PDM} in oversampled multibit PDM format.

The additional forward acoustic sensor 130 comprises an analog microphone 130a and a sigma-delta ND converter 130b coupled to the microphone 130a. The sigma-delta A/D converter 130b is configured to receive an analog audio signal from the microphone 130a and to convert the analog audio signal into a PDM microphone signal SM_{PDM} in oversampled PDM format. An input interface 131 of the playback unit 2 receives the PDM microphone signal SM_{PDM} and converts it into a PCM microphone signal SM_{PCM}, which is then supplied to a third input of the adder module. The input module 131 may include filters and a processing module, similar to the filters and processing modules of the signal processing stage 8 and of the acoustic noise processing stage 10.

A MEMS digital microphone may be used in place of the additional forward acoustic sensor 130 in another embodiment.

The solution described above entails several advantages.

First, the active noise cancelling function is based on PDM processing and sigma-delta modulator digital filters. On the one side, PDM systems usually exploit a high sampling frequency to produce an oversampled bitstream (3 MHz in the example described). On account of the high sample frequency, latency and delays in the active noise cancelling loop are low, to the benefit of the phase margin, and, accordingly, stability requirements may be easily met. Active noise cancelling function may be thus implemented by reliable fully digital systems.

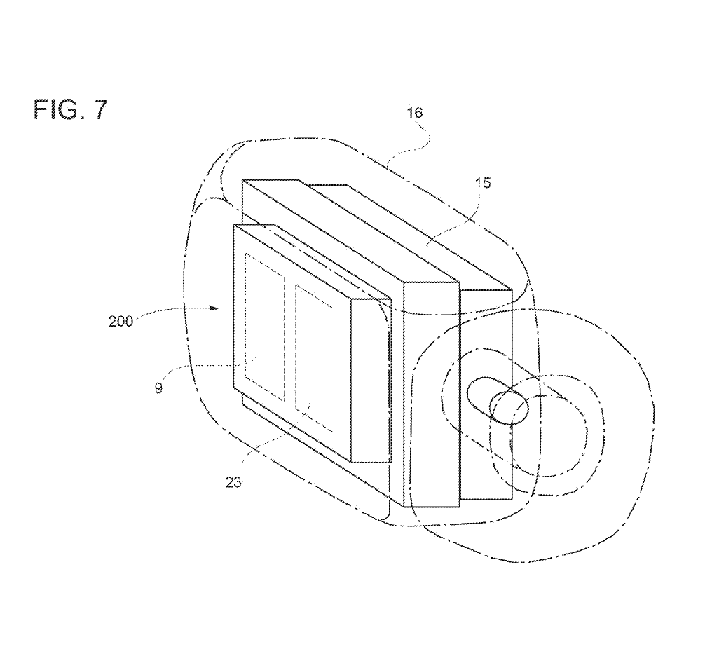

On the other hand, for a given performance level, sigma-delta modulator digital filters have simple structure that is much less demanding in terms of area occupation and power consumption compared to Digital Signal Processors. Thus, also miniaturization is favored to the extent that it is possible to design even in-ear headphones or hearing aids provided with respective active noise cancelling loops and remote processing is not required. For example, see FIG. 7, a single package 200 for in-ear headphones may include the MEMS microphone 9 and control circuitry comprising the active noise cancelling device 23, thus reducing the need for wiring. In this case, the casing 16 is configured to be inserted directly in a user's ear passage and the package 200 is enclosed within the casing 16 together with the loudspeaker 15. Also wireless in-ear headphones may be obtained.

Multibit PDM coding with a single bit for the sample value and a plurality of bits for the sample weight help to achieve extremely simplified structure. In fact, with this signal format shift registers are enough to implement multipliers, e.g., to apply forward and feedback filter coefficients of the control loop filters.

The sigma-delta modulator digital filters are also easily reconfigurable, since it is possible to adjust the forward and feedback filter coefficients by writing registers via software. Therefore, filter trimming is not as critical as with analog solutions.

Other advantages are associated with the use of a logarithmic quantizer in the control loop filters, especially a base-2 logarithmic quantizer. Indeed, logarithmic quantizer not only allows a broader dynamic range, but also contributes to reduce quantization noise (out of band noise). Quantization error is in fact correlated to the sample weight, so that the effect on sample having lower absolute value is mitigated.

Base-2 quantization puts the sampled signals already in the appropriate multibit PDM format, thereby simplifying processing.

Amplification of out-of-band noise present in the PDM signals is avoided by the use of low pass stages in combination with amplification gain.

Adding a zero at the Nyquist frequency in at least one of the control loop filters 20 contributes to reduce out-of-band noise and to avoid instability of the structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An active noise cancelling device, comprising:
a sensor configured to convert acoustic signals into first audio signals;
a speaker, acoustically coupled to the sensor; and
a control stage, configured to control the speaker based on the first audio signals and to cause the speaker to produce cancelling acoustic waves that tend to suppress acoustic noise components in the acoustic signals;
wherein the control stage comprises sigma-delta modulator digital filters.

2. The device according to claim 1, wherein the sigma-delta modulator digital filters have a transfer function configured to cancel acoustic noise at the sensor.

3. The device according to claim 2, wherein the sigma-delta modulator digital filters include a peak filter, a notch filter and a shelf filter.

4. The device according to claim 1, wherein the sigma-delta modulator digital filters are in the Cascade-of-Integrators FeedBack form.

5. The device according to claim 1, wherein the sigma-delta modulator digital filters comprise respective logarithmic quantizers.

6. The device according to claim 5, wherein the logarithmic quantizers are base-2 quantizers.

7. The device according to claim 1, wherein at least one of the sigma-delta modulator digital filters has a zero at the Nyquist frequency.

8. The device according to claim 1, wherein the first audio signals are in multibit PDM format.

9. The device according to claim 1, wherein the control stage comprises a processing module configured to convert a second audio signal received from the sigma-delta modulator digital filters into a third audio signal in PCM format.

10. The device according to claim 9, wherein the processing module has a low-pass transfer function and a bandpass gain greater than unity.

11. The device according to claim 10, comprising a signal processing stage configured to receive an input signal and to convert the input signal into a fourth audio signal in PCM format.

12. The device according to claim 11, wherein the signal processing stage comprises further sigma-delta modulator digital filters.

13. The device according to claim 12, comprising a driving stage configured to drive the speaker based on a combination of the third audio signal and fourth audio signal.

14. An electronic device, comprising:
at least one playback unit, each playback unit including,
a casing;
an acoustic sensor that converts acoustic signals into first audio signals;
a speaker acoustically coupled to the acoustic sensor; and
control stage circuitry being housed within the casing and electrically coupled to the acoustic sensor and the speaker, the control stage circuitry sigma-delta modulator filtering the first audio signals and controlling the speaker based on the filtered first audio signals to generate cancelling acoustic waves that reduce acoustic noise components in the acoustic signals.

15. The electronic device according to claim 14, wherein each playback unit is an earpiece.

16. The electronic device of claim 14, wherein the at least one playback unit comprises two playback units that form left and right earpieces contained in a headphone assembly.

17. A method for active noise cancelling, comprising:
converting acoustic signals present in a region into first audio signals;
sigma-delta modulator filtering the first audio signals signals to generate acoustic noise cancelling signals; and
controlling an acoustic transducer that is acoustically coupled to the region based on the acoustic noise cancelling signals to produce cancelling acoustic waves that tend to suppress acoustic noise components in the acoustic signals.

18. The method of claim 17, wherein sigma-delta modulator filtering the acoustic signals to generate acoustic noise cancelling signals comprises peak filtering followed by notch filtering followed by shelf filtering of the acoustic signals.

19. The method of claim 18, wherein controlling the acoustic transducer comprises controlling a speaker.

20. The method of claim 17, wherein converting acoustic signals present in a region into first audio signals comprises converting acoustic signals present in an ear of a person into the first audio signals.
